(19) United States
(12) Patent Application Publication
(10) Pub. No.: US 2016/0209856 A1
(43) Pub. Date: Jul. 21, 2016

(54) POWER RESTRICTION MANAGEMENT SYSTEM

(71) Applicant: LUXUL TECHNOLOGY INCORPORATION, New Taipei City (TW)

(72) Inventors: Cheng-Hung Pan, New Taipei City (TW); Eric Wen-Chien Chen, New Taipei City (TW); Perng-Fei Yuh, New Taipei City (TW); Chih-Hung Lin, New Taipei City (TW)

(21) Appl. No.: 14/794,320

(22) Filed: Jul. 8, 2015

(30) Foreign Application Priority Data
Jan. 21, 2015 (TW) 104102015

(51) Int. Cl. G05F 1/66; G05B 15/02

(52) U.S. Cl. CPC G05F 1/66; G05B 15/02

(57) ABSTRACT

A power restriction management system includes a network switching device with a preinstalled power restriction sequence value and a managing server. The network switching device is connected to a power source to acquire power and at least one electronic device to perform power restriction in the electronic device. The managing server is connected to the network switching device via Internet and controls the network switch device to perform power restriction in the corresponding electronic device or not according to the power restriction sequence value of the network switching device. The managing server controls the network switching device with the specific power restriction sequence value to perform power restriction in the corresponding electronic device. It is not to perform power restriction in all electronic devices without differentiation and the goal of the power restriction is achieved and impact and loss to the users can be reduced.

### CROSS-REFERENCE TO RELATED APPLICATIONS

This application claims the benefit of Taiwan patent application No. 104102015, filed on Jan. 21, 2015, the disclosure of which is incorporated herein in its entirety by reference.

### BACKGROUND OF THE INVENTION

1. Field of the Invention

The present invention relates to a power restriction management system, and more particularly to a power restriction management system implemented in a power plant for managing power consumption of electronic devices during a power restriction period.

2. Description of Related Art

Electric power has become one of the most important energies in human life. Most of the electronic merchandises in the market are driven by electric power, and the user can enjoy the use of the electronic merchandises. However, the total amount of the energy provided by the power plant is limited. When the power consumption from the end users is significantly increased, the total energy provided by the power company is not enough for all of the end users at the same time. Therefore, the power company usually performs a power restriction method to limit the power consumption for some of the end users and redistributes the power so as to avoid that the distribution of the power is too scattered and the power for each of the end users is not enough for normal use.

The conventional power restriction method is to implement power sectionalization to ration power at different time for different areas, and the users are able to acquire enough power to maintain normal usage when power is available. However, when the power company performs power restriction, some of the areas are not able to acquire power, the power for the specific area is cut off, and the power is distributed to other areas. The method will cause some of the users not able to use any electronic devices because the power supply is terminated.

For example, when a power company is required to provide power for A city and B city at the same time and the power usage in A city and B city is significantly increased during peak time, the total power provided by the power company is not increased and the total power is not enough to meet the demand. Therefore, the power sectionalization method is implemented to provide power to A city and B city. From 8 a.m. to 12 p.m., the power is provided in A city, and from 12 p.m. to 5 p.m., the power is provided in B city. The users in A city and B city can acquire enough power for normal use.

When the power company performs power restriction, all of the power in A city is cut off and the electronic devices of the users in A city cannot be used. Some of the electronic devices (such as life-support equipments in hospitals, company servers and so on) are required emergency power and cannot be cut off. If the power is cut off, huge loss and irreparable damage will occur. Therefore, the current power restriction management method used by the power company is necessary to be improved.

### SUMMARY OF THE INVENTION

Accordingly, an objective of the present invention is to provide a power restriction management system to improve the restriction management and reduce the damage of the users.

The power restriction management system comprises:

at least one network switching device preset with a power restriction sequence value and electrically connected to a power source and at least one electronic device so as to control whether power provided to the electronic device is rationed or not; and

a managing server connected to the network switching device via Internet and controlling the electronic device to or not to ration the power provided by the power source to the electronic device connected to the network switching device in accordance with the power restriction sequence value of the network switching device.

The present invention provides the managing server and the power restriction sequence value preinstalled in the network switching device for a power company to determine whether the power restriction is performed to the electronic device, which is corresponding to the network switching device. The power restriction sequence value is determined in accordance with the priority of the power usage of the electronic devices connected to the network switching device by the users or the power company. For example, when the electronic device is a lamp, the power restriction sequence value thereof is 1; when the electronic device is a company server, the power restriction sequence value thereof is 2; when the electronic device is life-support equipment in the hospital, the power restriction sequence value thereof is 3.

Thereafter, when the power company must perform power restriction during the peak time, power to the electronic device with the power restriction sequence value 1 is cut off to reduce power consumption and achieve the purpose of the power restriction in accordance with the power restriction sequence value corresponding to the network switching device. When power to the electronic device with the power restriction sequence value 1 has been cut off and the power consumption is not lowered to a required amount, power to the electronic device with the power restriction sequence value 2 is further cut off and so on and so forth to achieve the required amount of power restriction. The present invention performs power restriction sequentially to the electronic devices for the power users instead of shutting down the power in the whole area so as to reduce the impact and damage caused by the power restriction.

### BRIEF DESCRIPTION OF THE DRAWINGS

FIG. 1 is a block diagram of a power restriction management system in a first preferred embodiment of the present invention;

FIG. 2 is a block diagram of the power restriction management system in a second preferred embodiment of the present invention;

FIG. 3 is a block diagram of the power restriction management system in a third preferred embodiment of the present invention; and

FIG. 4 is a block diagram of a network switching device of the power restriction management system of the present invention.

### DETAILED DESCRIPTION OF THE PREFERRED EMBODIMENT

These and other aspects of the embodiments herein will be better appreciated and understood when considered in conjunction with the following description and the accompanying drawings.

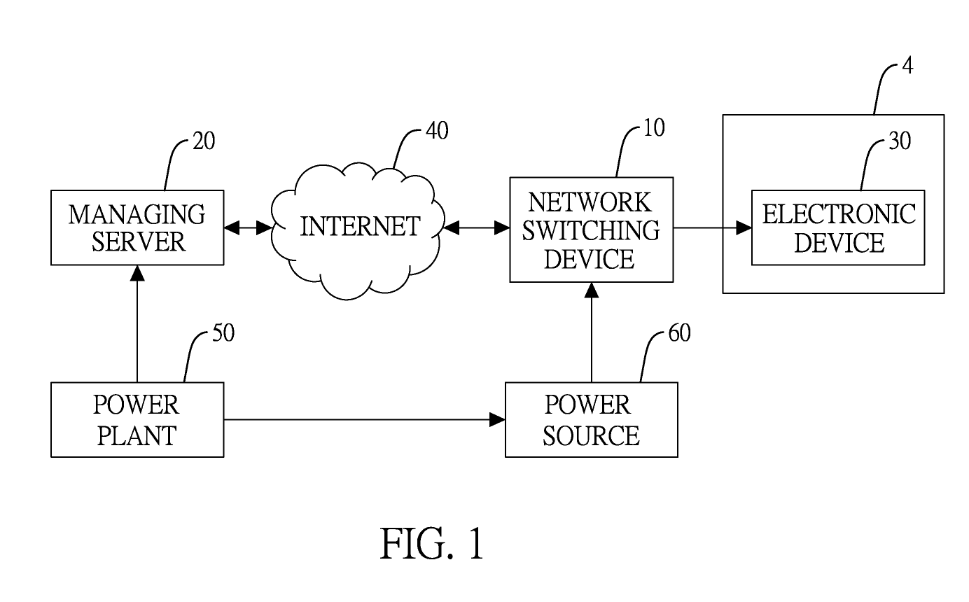

With reference to FIG. 1, the present invention relates to a power restriction management system. The power restriction management system in a first preferred embodiment includes at least one network switching device 10 and a managing server 20.

The network switching device 10 is preset with a power restriction sequence value and is connected to a power source 60 and a device module 4 to control whether the power provided to the electronic device is restricted or not. The device module 4 in the present embodiment includes one electronic device 30. The managing server 20 is connected to the network switching device 10 via Internet 40 and controls the network switching device 10 in accordance with the power restriction sequence value of the network switching device 10 to or not to perform power restriction to the corresponding electronic device 30.

Since the power restriction sequence value is preinstalled in the network switching device 10 and the network switching device 10 is connected to the Internet 40, the managing server 20 can be connected to the network switching device 10 via the Internet 40 and the power managing server 20 can control the network switching device 10 to perform the power restriction in the electronic device 30 according to the corresponding power restriction sequence value. In the preferred embodiment, the network switching device 10 can be a plug, a lamp switch, a circuit breaker or an electronic plug, but it is not limited herein.

The power restriction sequence value is determined in accordance with priority of the power usage of the electronic device 30, which is set up by the user or the power company. For example, when the electronic device 30 is a lamp, the power restriction sequence value of the electronic device 30 is 1; when the electronic device 30 is a company server, the power restriction sequence value of the electronic device 30 is 2, and when the electronic device 30 is life-support equipment in the hospital, the power restriction sequence value of the electronic device 30 is 3.

Generally, the power of the electronic device 30 is acquired from the power source 60 and the electronic device 30 can work properly. Therefore, during the peak time, a power plant 50 must perform power restriction for the user to use power properly. The power plant 50 performs power restriction via the managing server 20 connected to the network switching device 10 through the Internet 40 and starts power restriction from the electronic device 30 with the lowest power restriction sequence value so as to reduce power consumption and achieve the purpose of the power restriction. In other words, the power to the lamp with the power restriction sequence value 1 is restricted. After power to the electronic device 30 with the power restriction sequence value 1 has been cut off and the required amount of power restriction is not achieved yet, the electronic device 30 with the power restriction value 2, which is greater than the lowest power restriction value, is subjected to power restriction and the power consumption is further decreased to achieve the required amount of power restriction. In other words, power restriction is performed to the computer with the power restriction sequence value 2 and so on and so forth until the electronic devices 30 corresponding to the power restriction values are all under power restriction. In other words, the lamp, the server and the life-support equipment with the power restriction values 1, 2 and 3 are all under power restriction. In the present invention, the power of the electronic devices 30 is sequentially restricted in accordance with the power restriction values. The conventional power restriction method is to cut off the power supply from the power source 60 by the power plant 50 directly and shut down all of the electronic devices 30. Accordingly, the power restriction management system in the present invention has less impact on the power usage of the user, and less loss and damage caused by the power restriction comparing to the conventional power restriction method.

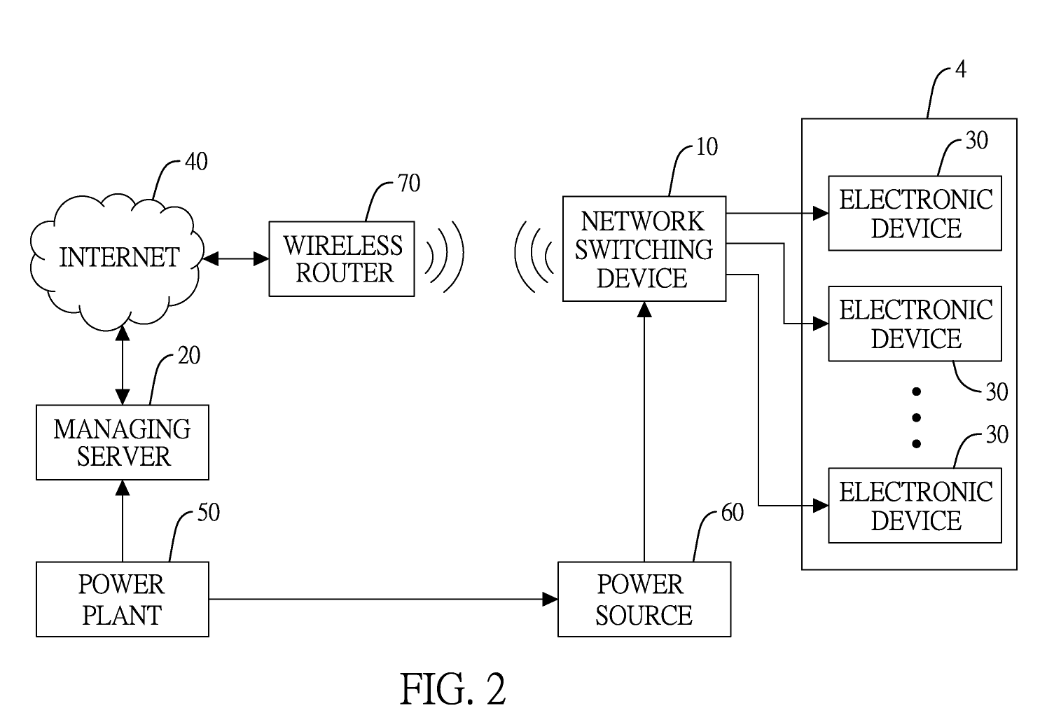

With reference to FIG. 2, in the present invention, the power restriction management system in the second embodiment is similar to in the first embodiment. The difference between the first embodiment and the second embodiment is that the network switching device 10 can restrict power multiple electronic devices and the network switching device 10 can control a device module 4 having a plurality of the electronic devices 30 to perform power restriction or not at the same time. Accordingly, the networking switching devices 10 are corresponding to the same one of the power restriction sequence values.

In addition, the power restriction management system further includes a wireless router 70 and the wireless router 70 is connected to the Internet 40. The network switching device 10 includes a wireless connecting function and can be wirelessly connected to the wireless router 70. The network switching device 10 is further connected to the Internet 40 via the wireless router 70. By the wireless connection method, the usage of the wires can be reduced. The network switching device 10 can not only be connected to the Internet 40, but also the convenience of the installation of the network switching device 10 is enhanced.

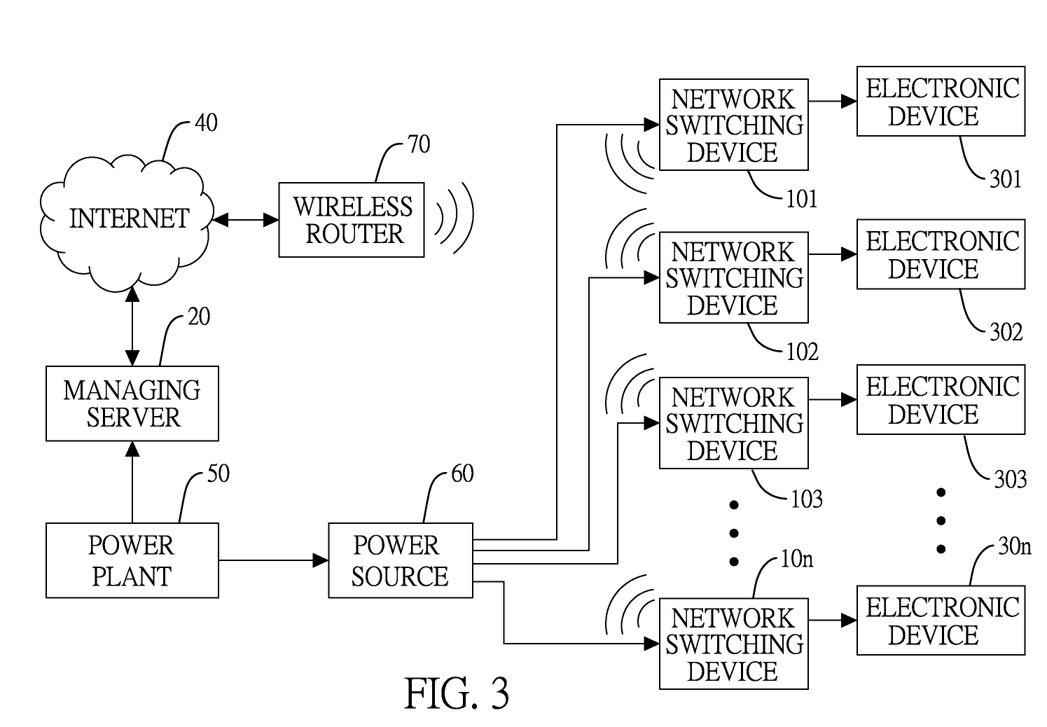

With reference to FIG. 3, the power restriction management system in the third embodiment is similar to in the second embodiment. The difference between the second embodiment and the third embodiment is that the power restriction management system includes a plurality of the network switching devices 10 and each of the network switching devices 10 can control at least one electronic device 30. Each of the network switching devices 10 is connected to the power source to acquire power energy so as to provide power to one of the corresponding electronic devices 30.

For example, the power restriction management system includes three network switching devices 10, which are respectively a first, a second, and a third network switching device 101-103. The first, the second, and the third network switching devices 101-103 respectively correspond to a first, a second, and a third electronic device 301-303. A power restriction sequence value 1 is preinstalled in the first network switching device 101, a power restriction sequence value 2 is preinstalled in the second network switching device 102, and a power restriction sequence value 3 is preinstalled in the third network switching device 103. The power restriction sequence value 3 represents that the power is never restricted. The power restriction sequence value 2 represents that the power can be restricted in case of emergency. The power restriction sequence value 1 represents that the power can be restricted when required.

When the power plant 50 must perform power restriction, the first network switching device 101 with the power restriction sequence value 1 is turned off to restrict power to the first electronic device 301. When the first network switching device 101 is turned off and the required amount of power restriction is not achieved yet or emergency occurs and the emergency usage of the power is required, the second network switching device 102 with the power restriction sequence value 2 is turned off to restrict the power to the second electronic device 302. The restriction amount of the power is achieved or the power is restricted to provide power for the regions requiring emergency use. The third network switching device 103 with the power restriction sequence value 3 never performs power restriction.

Furthermore, when the power plant 50 would like to collect the utility bills, different utility rates can be collected in accordance with the power restriction sequence values preinstalled in the network switching devices 30 so as to avoid waste of power. For example, the power plant 50 would like to collect 5 dollars per kilowatt hour from the power consumption of the first electronic device 301 connected to the first network switching device 101 with the power restriction value 3. The power plant 50 would like to collect 4 dollars per kilowatt hour from the power consumption of the first electronic device 302 connected to the second network switching device 102 with the power restriction value 2. The power plant 50 would like to collect 3 dollars per kilowatt hour from the power consumption of the first electronic device 303 connected to the third network switching device 103 with the power restriction value 1. By collecting different rates to control the usage amount, waste of power can be avoided.

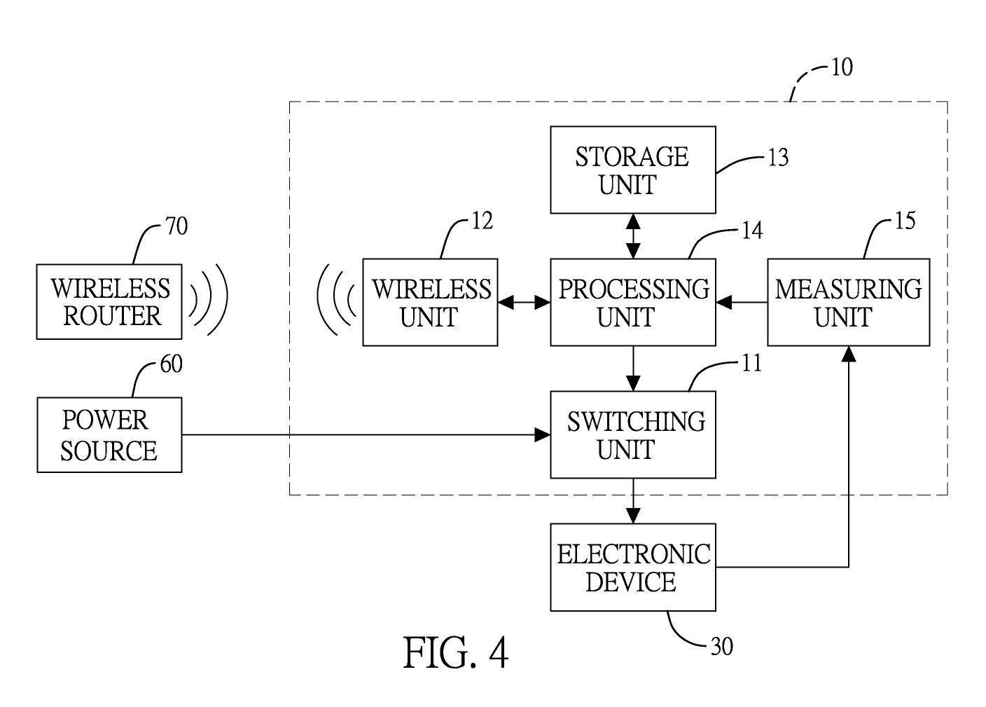

With reference to FIG. 4, the network connecting device 10 includes a switching unit 11, a wireless unit 12, a storage unit 13 and a processing unit 14.

The switching unit 11 is connected between the power source 60 and the electronic device 30. The wireless unit 12 receives a control signal wirelessly and the control signal corresponds to a power restriction comparing value. The storage unit 13 is to store the power restriction sequence value preinstalled in the network switching device. The preinstalled power restriction sequence value can be set up via the Internet 40 from the managing server 20 or the preinstalled power restriction sequence value can be setup directly from a terminal equipment (not shown in the figures) by a user. For example, the terminal equipment can be a smart phone or a computer of the user or a physical keyboard disposed on the network switching device 10.

The processing unit 14 is electrically connected to the storage unit 13, the wireless unit 12 and the switching unit 11 and is configured for receiving the control signal and determining whether the power restriction comparing value corresponding to the control signal is greater than the power restriction sequence value stored in the storage unit 13. If the power restriction comparing value is greater than the power restriction sequence value, the switching unit 11 is shut down and the power resource 60 won't provide power to the electronic device 30.

The network switching device 10 is controlled to be turned on or off and the power supply to the electronic device 30 is cut off or not by determining whether the power restriction comparing value corresponding to the control signal is greater than the power restriction sequence value. In accordance with the setup of the power restriction sequence value, when the power plant 50 is required to perform the power restriction, different network switching devices 10 can be shut down according to a different situation to restrict power supply and reduce power usage in many network switching devices 10 with different power restriction sequence values. In addition, the network switching device 10 with the power restriction sequence value 3 is never shut down to reduce and avoid the damage caused by the power restriction.

Furthermore, the network switching device 10 further includes a measuring unit 15 and the measuring unit 15 is connected to the processing unit 14 to measure the power usage of the electronic device 30 so as to output the voltage, the current, the power, the power usage, and the power factor of the electronic device 30. The measuring unit 15 is wirelessly connected to the wireless router 70 so as to be connected to the Internet 40 or directly connected to the Internet 40, and the voltage, the current power, the power usage and the power factor of the electronic device 30 are transmitted and stored in the managing server 20. For example, the measured data of the measuring unit 15 is to record the power usage of the electronic device 30 every 15 minutes, every hour, every day or every week in accordance with a time sequence and is stored in the managing server 20 as a history record and a reference for the power plant 50 so as to set up the power restriction sequence values for every network switching device 10. Moreover, the power plant 50 can detect the power usage of the electronic device 30 via the Internet 40 at any time and any moment.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A power restriction management system, comprising:
a network switching device preset with a power restriction sequence value and electrically connected to a power source and a device module so as to control whether power provided to the device module is rationed or not; and
a managing server connected to the network switching device via Internet and controlling the device module to or not to ration the power provided by the power source to the device module connected to the network switching device in accordance with the power restriction sequence value of the network switching device.

2. The power restriction management system as claimed in claim 1, wherein the device module comprises an electronic device, and the network switching device is connected to the electronic device so as to control whether the power provided to the electronic device is rationed or not.

3. The power restriction management system as claimed in claim 1, wherein the device module comprises a plurality of electronic devices, and the network switching device is connected to the electronic devices so as to control whether the power provided to the electronic devices is rationed or not.

4. The power restriction management system as claimed in claim 2 further comprising a wireless router connected to the Internet and wirelessly connected to the network switching device for connecting the network switching device to the Internet.

5. The power restriction management system as claimed in claim 3, further comprising a wireless router connected to the Internet and wirelessly connected to the network switching device for connecting the network switching device to the Internet.

6. The power restriction management system as claimed in claim 1, wherein the network switching device includes:
a switching unit connected between the power source and the device module;
a wireless unit wirelessly receiving a control signal and the control signal corresponding to a power restriction comparing value;
a storage unit storing the power restriction sequence value preset in the network switching device; and
a processing unit connected to the storage unit, the wireless unit, and the switching unit, the processing unit receiving the control signal and determining whether the power restriction comparing value corresponding to the control signal is greater than the restriction power sequence value stored in the storage unit, and the power source providing power to the electronic device when the control signal is greater than the restriction power sequence value.

7. The power restriction management system as claimed in claim 6, wherein the network switching device further includes:
a measuring unit connected to the processing unit to measure power consumption of the electronic device and to output voltage, current, power, power usage, and power factor of the electronic device to the processing unit, and the processing unit transmitting the voltage, the current, the power, the power usage, and the power factor of the electronic device to the managing server via the wireless unit, the wireless router and the Internet, the managing server storing the voltage, the current, the power, the power usage, and the power factor of the electronic device.

8. The power restriction management system as claimed in claim 1, wherein the network switching device is a plug, a lamp switch, a circuit breaker or an electronic plug.

9. A power restriction management system, comprising:
a plurality of network switching devices respectively preset with power restriction sequence values and electrically connected to a power source and a plurality of electronic devices so as to control whether power provided to the electronic devices is rationed or not; and
a managing server connected to the network switching devices via Internet and controlling the electronic devices to or not to ration the power provided by the power source to the electronic devices connected to the network switching devices in accordance with the power restriction sequence values of the network switching devices.

10. The power restriction management system as claimed in claim 9, wherein the network switching devices are respectively preset with power restriction sequence values, and
the managing server is connected to the electronic devices and rations the power to the electronic devices in accordance with priorities of the power restriction sequence values of the network switching devices.

11. The power restriction management system as claimed in claim 9 further comprising a wireless router connected to the Internet and wirelessly connected to the network switching devices for connecting the network switching devices to the Internet.

12. The power restriction management system as claimed in claim 10, further comprising a wireless router connected to the Internet and wirelessly connected to the network switching devices for connecting the network switching devices to the Internet.

13. The power restriction management system as claimed in claim 9, wherein each of the network switching devices includes:
a switching unit connected between the power source and the electronic devices;
a wireless unit wirelessly receiving a control signal and the control signal corresponding to a power restriction comparing value;
a storage unit storing the power restriction sequence value preset in the network switching device; and
a processing unit connected to the storage unit, the wireless unit, and the switching unit, the processing unit receiving the control signal and determining whether the power restriction comparing value corresponding to the control signal is greater than the restriction power sequence value stored in the storage unit, and the power source providing power to the electronic device when the control signal is greater than the restriction power sequence value.

14. The power restriction management system as claimed in claim 13, wherein each of the network switching devices further includes:
a measuring unit connected to the processing unit to measure power consumption of the electronic device and to output voltage, current, power, power usage, and power factor of the electronic device to the processing unit, and the processing unit transmitting the voltage, the current, the power, the power usage, and the power factor of the electronic device to the managing server via the wireless unit, the wireless router and the Internet, the managing server storing the voltage, the current, the power, the power usage, and the power factor of the electronic device.

15. The power restriction management system as claimed in claim 9, wherein each of the network switching devices is a plug, a lamp switch, a circuit breaker or an electronic plug.
